(19) United States
(12) Patent Application Publication
(10) Pub. No.: US 2009/0156344 A1
(43) Pub. Date: Jun. 18, 2009

(54) Conveyor belt and method for producing the same

(75) Inventors: Kai-Jen Hsiao, Hsinchu (TW); Shu-Hui Cheng, Hsinchu (TW); Shu-Pyng Lee, Hsinchu (TW)

Correspondence Address: BACON & THOMAS, PLLC, 625 SLATERS LANE, FOURTH FLOOR, ALEXANDRIA, VA, 22314-1176, US

(73) Assignee: Industrial Technology Research Institute, Hsinchu (TW)

(21) Appl. No.: 12/078,825

(22) Filed: Apr. 7, 2008

(30) Foreign Application Priority Data
Dec. 13, 2007 (TW) 96147613

(51) Int. Cl. F16G 1/10; B29D 29/06

(52) U.S. Cl. 474/263; 156/137

(57) ABSTRACT

The present invention provides a conveyor belt fabricated from a gray cloth weaved from tetragonal fibers. The conveyor belt of the present invention reduces the amount of rubber to achieve desired lightweight, with more preferable tensile strength and elongation at break than conveyor belts fabricated from circular fibers.

### FIELD OF THE INVENTION

The present invention relates to a light-weighted conveyor belt. More particularly, the present invention relates to a method, which utilizes tetragonal fibers for the production of conveyor belts.

### BACKGROUND OF THE INVENTION

Most traditional artificial fibers are provided with circular cross-sections. Many inter-fiber voids would be formed when stacking, resulting in inter-fiber rolling and sliding, which would weaken the strength and the sustainability of the weave produced. Conventional techniques typically involve applying resin onto the weave surface, or using high-shrinkage fibers in order to reduce inter-fiber voids. However, the bulk use of resin would not only induce environmental problems such as pollution, but also increase the production costs. In another aspect, for weaves produced by using high-shrinkage fibers, the control of the final density and the basis weight after shrinking is also a potential problem to be solved. Moreover, typical high-shrinkage fibers are not provided with the necessary tensile strength for industrial applications.

Conveyor belts are traditionally fabricated through calendering the circular fiber layer, the adhesion layer, and the rubber layer. However, conveyor belts produced by using such method are extremely heavy. For example, for a conveyor belt with a width of 0.9 m and a length of 300 m, the weight is approximately 6 kg per square meter, for which the weight of the whole set would become 1620 kg in total.

In order to solve the problems arising from the traditional use of circular fibers for the production of conveyor belts, it is worth researching for a method to produce light-weighted, wearing-resistant conveyor belts with high sustainability.

### SUMMARY OF THE INVENTION

The objective of the present invention is to provide a light-weighted conveyor belt without affecting the tensile strength and the elongation at break. Another objective of the present invention is to develop novel uses of tetragonal fibers, for which the property of tetragonal fibers when stacking may be utilized on weaves with novel effects.

Accordingly, the conveyor belt of the present invention has the following components: a gray cloth; an adhesion layer, which is provided with a first surface and a second surface, wherein said first surface is combining with the gray cloth; and a rubber layer, which is combining with the second surface of said adhesion layer; wherein said gray cloth is fabricated by fibers, and said fibers at least contain parts as tetragonal fiber.

The present invention also includes a method for fabricating said conveyor belt, including the following steps: obtaining a gray cloth, which is weaved from fibers, and said fibers at least contain parts as tetragonal fiber; dipping said gray cloth in conveyor belt strengthening reagents; forming an adhesion layer on top of said gray cloth surface, and forming a rubber layer on top of said adhesion layer.

The present invention further comprises a use of tetragonal fibers for the production of conveyor belts.

The present invention has demonstrated a conveyor belt fabricated by tetragonal fibers. Comparing to traditional circular fibers, for which bulk amounts of rubber is required to reduce the undesirable inter-fiber movements such as rolling and sliding, since tetragonal fibers can stack tightly, the stress applied would be transferred through faces to reduce the undesirable inter-fiber movements, and would therefore be able to reduce the use of rubber by 20%. In the previous example, the conveyor belt weighted 1620 kg would be significantly lightened through the 324 kg rubber reduction.

### BRIEF DESCRIPTIONS OF THE DRAWINGS

FIG. 1 illustrates the structure of the conveyor belt of the present invention.

### DETAILED DESCRIPTION OF THE PREFERABLE EMBODIMENTS

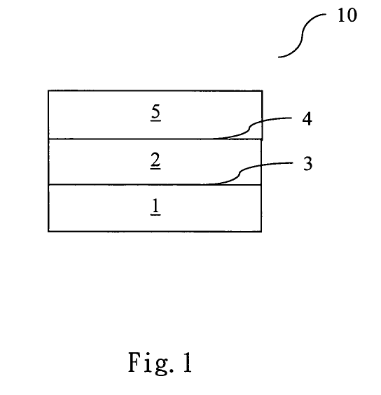

The conveyor belt (10) of the present invention has the following components as shown on FIG. 1: a gray cloth (1); an adhesion layer (2) with a first surface (3) and a second surface (4), wherein said first surface is combining with said gray cloth; a rubber layer (5), which is combining with the second surface (4) of said adhesion layer (2). The gray cloth is weaved from fibers, and said fibers at least contain parts as tetragonal fiber.

The ‘tetragonal fiber’ referred to in the present invention is fabricated by: melting a thermoplastic polymer forming polymer melts, extruding the polymer melt through a spinneret, passing through a shortened air-blocked zone, thus obtaining the product by speeding the solidification process of the filamentary fluid. Adjustment of spinning conditions is also required for forming and sustaining the tetragonal cross-section of the fiber. The spinneret to be used in the present invention can be any spinneret able to form tetragonal fibers, preferably “tetragonal-like” spinnerets.

The ‘tetragonal fiber’ referred to here is preferably a rectangular fiber, more preferably a square fiber. Generally, length-to-width radio of said tetragonal fiber produced by the method mentioned previously is 1.0-2.0, and the material used for fabricating said tetragonal fiber is partially oriented yarn (POY), fully oriented yarn (FOY), or spin draw yarn (SDY).

The material of the fiber is a thermoplastic polymer, copolymers or mixtures thereof. The thermoplastic polymer is including, but not limited to polyamide resin, polyester, or polyolefin, copolymers or mixtures thereof; the more preferred polyamide resin is the nylon series, for example: Nylon 6, Nylon 11, Nylon 12, Nylon 46, Nylon 66, Nylon 610, Nylon 612, copolymers or mixtures thereof. Other polyamide resins suitable for the present invention are exemplified in J. Gordon Cook “Handbook of Textile Fibres” 5^{th} Ed., Trowbridge GB (1984), pp. 19-20. The polyester used in the present invention is including, but not limited to polyethylene terephthalate (PET), polytrimethylene terephthalate (PTT), polybutylene terephthalate (PBT), copolymers or mixtures therof. The polyolefin used in the present invention is including, but not limited to polyethylene (PE), polypropylene (PP), polybutylene, copolymers or mixtures thereof.

The “adhesion layer resin material” referred to in the present invention can be selected from any known materials used for forming the adhesion layer of conveyor belts, including but not limited to natural rubber (NR), styrene butadiene rubber (SBR), polyisoprene rubber (IR), polybutadiene rubber (BR), butyl rubber (IIR), ethylene-propylene polymer (EPM or EPR), ethylene propylene diene monomer (EPDM), neoprene (CR), nitrile-butadiene rubber (NBR), polyurethane rubber (AU and EU), polysulfide (T), epichlorohydrin rubber (CO and ECO), silicon rubber (MQ), hypalon (CSM), chlorinated rubber (CFM), Acrylic rubber (ACM), copolymers, mixtures, or additives thereof.

The “rubber layer material” referred to in the present invention can be selected from any known materials used for forming the rubber layer of conveyor belts, including but not limited to natural rubber (NR), styrene butadiene rubber (SBR), polyisoprene rubber (IR), polybutadiene rubber (BR), butyl rubber (IIR), ethylene-propylene polymer (EPM or EPR), ethylene propylene diene monomer (EPDM), neoprene (CR), nitrile-butadiene rubber (NBR), polyurethane rubber (AU and EU), polysulfide (T), epichlorohydrin rubber (CO and ECO), silicon rubber (MQ), hypalon (CSM), chlorinated rubber (CFM), Acrylic rubber (ACM), copolymers, mixtures, or additives thereof.

The conveyor belt of the present invention comprises: a gray cloth, an adhesion layer, and a rubber layer, wherein said rubber layer is in contact with the object to be carried in real life applications. However, in some embodiments, the other face of the conveyor belt, in other words the two faces of the gray cloth can both be provided with the adhesion layer and the rubber layer, the contact face of the conveyor belt and the conveyor machine is thus provided with the adhesion layer and the rubber layer. In more preferable embodiments, due to the friction and collision of the rubber layer with the object to be carried, the thickness of such rubber layer is greater than the rubber layer in contact with the conveyor machine.

The method for fabricating the conveyor belt of the present invention is including the following steps: obtaining a gray cloth, which is weaved from fibers, and said fibers at least contain parts as tetragonal fiber; dipping said gray cloth in conveyor belt strengthening reagents; forming an adhesion layer on top of said gray cloth surface; and forming a rubber layer on top of said adhesion layer.

The conveyor belt strengthening reagent can be selected from any reagents known to be used for dipping the gray cloth in the production of conveyor belts, including but not limited to resorcinol, formalin, latex, copolymers, mixtures, or additives thereof.

Roller-calendering is used for combining the gray cloth, the adhesion layer, and the rubber layer. The operation conditions related, for example the pressure and temperature can be adjusted in accordance to the properties of the tetragonal fiber, the adhesion layer, and the rubber layer. The material and the related descriptions of the tetragonal fiber, the adhesion layer, and the rubber layer are as mentioned previously.

In summary, the present invention includes a use of utilizing tetragonal fibers for the production of conveyor belts, wherein the material and the related descriptions of the tetragonal fiber are as mentioned previously.

The following examples are used to further illustrate the technological features and advantages of the present invention. However, these examples are not to be used to limit the scope of the present invention.

### EXAMPLE

### The Comparison of the Tetragonal Fiber Conveyor Belt and the Circular Fiber Conveyor Belt

In order to illustrate the advantages of the present invention, a circular fiber and a square fiber were both obtained and tested with rubber layers of different thickness. The sample and the related parameters are as shown below:

TABLE 1
The comparison of conveyor belts of different specifications

| | | gray cloth material | |
|---|---|---|---|
| | | Warp yarn | Weft yarn |
| conveyor belt code^{} | | (PET 1000D) | (Nylon 66 840D) |
| A1 | Upper rubber | Far Eastern Ltd. | Formosa Chemicals & |
| | thickness 5 mm | (circular yarn) | Fibre Corp. (circular |
| | | | yarn) |
| A2 | Upper rubber | Far Eastern Ltd. | Industrial Technology |
| | thickness 5 mm | (circular yarn) | Research Institute |
| | | | (square yarn) |
| B1 | Upper rubber | Far Eastern Ltd. | Formosa Chemicals & |
| | thickness 3 mm | (circular yarn) | Fibre Corp. (circular |
| | | | yarn) |
| B2 | Upper rubber | Far Eastern Ltd. | Industrial Technology |
| | thickness 3 mm | (circular yarn) | Research Institute |
| | | | (square yarn) |

* Group A conveyor belt specification: 900 × 4P(EP-100) × 5 × 1.6 × 300. Group B conveyor belt specification: 900 × 4P(EP-100) × 5 × 1.6 × 300; width (mm) × number of layers of the strengthened material (the specification of the material) × upper rubber thickness (mm) × lower rubber thickness (mm) × length (m). Therefore, the upper rubber thickness for group A is 5 mm, and the upper rubber thickness for group B is 3 mm.

Fatigue testing is conducted for the four groups of conveyor belts of different specifications (according to CNS746K6052, testing properties after 15,000 times of reverse movements). The results are as shown on the table below:

TABLE 2
The comparison of the tensile strength, the elongation at break,
and the tensile strength sustainability of conveyor belts of different
specifications before and after fatigue testing

| | Before | | | | The tensile |
|---|---|---|---|---|---|
| | fatigue testing | | After fatigue testing | | strength |
| | Tensile | Elongation | Tensile | Elongation | sustainability |
| conveyor | strength | after break | strength | after break | after fatigue |
| belt code | (N/mm) | (%) | (N/mm) | (%) | testing (%) |
| A1 | 511 | 16 | 400 | 11 | 78.3 |
| A2 | 472 | 16 | 410 | 20 | 86.9 |
| B1 | 395 | 12 | 303 | 11 | 76.7 |
| B2 | 448 | 20 | 404 | 15 | 90.2 |

As shown on the table above, the tensile strength sustainability of the circular fiber conveyor belt is significantly lower than the tetragonal fiber. Moreover, after reducing the thickness of the rubber layer of the circular fiber conveyer from 5 mm to 3 mm, the tensile strength also decreases significantly. On the other hand, after reducing the rubber layer of the tetragonal fiber conveyor belt from 5 mm to 3 mm, the tensile strength and the elongation after break after fatigue testing is similar, without significant decrease according to the reduction of thickness.

In summary, the conveyor belt of the present invention is using tetragonal fibers in order to reduce the rolling and sliding movements between the adhesion layer and the fiber, and therefore to reduce the use of rubber by 20%. The conveyor belt produced is provided with lightweight, and more preferable tensile strength and elongation after break than circular fibers.

### Other Embodiments

The present invention has been exemplified by the more preferable embodiments as previously mentioned. However, these examples are not used to limit this invention, and those skilled in the art can make a variety of alterations and modifications without departing the spirit and scope of this invention. Such modifications are intended to be within the scope of the claims.

What is claimed is:

1. A conveyor belt, comprising:
a gray cloth;
an adhesion layer, which is provided with a first surface and a second surface, wherein said first surface is combining with the gray cloth, and
a rubber layer, which is combining with said adhesion layer, wherein said gray cloth is fabricated by fibers, and said fibers at least contain parts as tetragonal fiber.

2. The conveyor belt according to claim 1, wherein said tetragonal fiber is partially oriented yam (POY), fully oriented yarn (FOY), or spin draw yarn (SDY).

3. The conveyor belt according to claim 2, wherein said tetragonal fiber is a rectangular fiber.

4. The conveyor belt according to claim 3, wherein said rectangular fiber is a square fiber.

5. The conveyor belt according to claim 1, wherein the length-to-width radio of said tetragonal fiber is 1.0-2.0.

6. The conveyor belt according to claim 1, wherein the material of said fibers is a thermoplastic polymer.

7. The conveyor belt according to claim 6, wherein said thermoplastic polymer comprises polyamide resin, polyester, polyolefin, copolymers or mixtures thereof.

8. The conveyor belt according to claim 7, wherein said polyamide resin comprises Nylon 6, Nylon 11, Nylon 12, Nylon 46, Nylon 66, Nylon 610, Nylon 612, copolymer or mixtures thereof.

9. The conveyor belt according to claim 7, wherein said polyester comprises polyethylene terephthalate (PET), polytrimethylene terephthalate (PTT), polybutylene terephthalate (PBT), aromatic polyester, aliphatic polyester, copolymers or mixtures thereof.

10. The conveyor belt according to claim 7, wherein said polyolefin comprises polyethylene (PE), polypropylene (PP), Polybutylene, copolymers or mixtures thereof.

11. The conveyor belt according to claim 1, further comprising a second adhesion layer and a second rubber layer, wherein said second adhesion layer is combining with said gray cloth, and said rubber layer is combining with said second adhesion layer.

12. A method of fabricating said conveyor belt according to claim 1, including the following steps:
obtaining a gray cloth, which is weaved from fibers, and said fibers at least contain parts as tetragonal fiber;
dipping said gray cloth in conveyor belt strengthening reagents;
forming an adhesion layer on top of said gray cloth surface, and
forming a rubber layer on top of said adhesion layer.

13. An use of utilizing tetragonal fibers for the production of conveyor belts.

14. The use according to claim 13, wherein said tetragonal fiber is partially oriented yarn (POY), fully orientated yarn (FOY), or spin draw yarn (SDY).

15. The use according to claim 13, wherein said tetragonal fiber is a rectangular fiber

16. The use according to claim 15, wherein said rectangular fiber is a square fiber.

17. The use according to claim 13, wherein the length-to-width radio of said tetragonal fiber is 1.0-2.0.

18. The use according to claim 13, wherein the material of said fiber is a thermoplastic polymer.

19. The use according to claim 18, wherein said thermoplastic polymer comprises polyamide resin, polyester, polyolefin, copolymers or mixtures thereof.

20. The use according to claim 19, wherein said polyamide resin comprises Nylon 6, Nylon 11, Nylon 12, Nylon 46, Nylon 66, Nylon 610, Nylon 612, copolymers or mixtures thereof.

21. The use according to claim 19, wherein said polyester comprises polyethylene terephthalate (PET), polytrimethylene terephthalate (PTT), polybutylene terephthalate (PBT), aromatic polyester, aliphatic polyester, copolymers or mixtures thereof.

22. The use according to claim 19, wherein said polyolefin comprises polyethylene (PE), polypropylene (PP), Polybutylene, copolymers or mixtures thereof.
